(19) United States
(12) Patent Application Publication
(10) Pub. No.: US 2025/0069136 A1
(43) Pub. Date: Feb. 27, 2025

(54) CREDIT RISK ASSESSMENT SYSTEMS AND METHODS

(71) Applicant: Royal Bank of Canada, Toronto (CA)

(72) Inventors: Hashim Khawaja, Edmonton (CA); Dien Ngoc Nguyen, Toronto (CA); A Ram Kang, Vancouver (CA); Shawn Lu, Toronto (CA); Adam Katt, Toronto (CA); Zeyu Wang, Toronto (CA); Amir Memartoluie, Oakville (CA); Jun Yuan, Toronto (CA)

(21) Appl. No.: 18/807,308

(22) Filed: Aug. 16, 2024

Related U.S. Application Data
(60) Provisional application No. 63/534,149, filed on Aug. 23, 2023.

(51) Int. Cl. G06Q 40/03

(52) U.S. Cl. CPC G06Q 40/03

(57) ABSTRACT

Methods, systems, and techniques for automatically assessing credit risk of a counterparty are disclosed. A credit risk assessment method comprises: quantifying a relevance of news topics to one or more credit risk keywords; determining one or more relevant news topics that are relevant to the one or more credit risk keywords; obtaining a plurality of news articles each tagged with one or more news topics and having an associated sentiment; determining a relevant news article as a news article tagged with the one or more relevant news topics; and assessing a credit risk of a counterparty based at least in part on the sentiment of the relevant news article.

### CROSS-REFERENCE TO RELATED APPLICATIONS

This application claims priority to U.S. Provisional Patent Application No. 63/534,149, filed on Aug. 23, 2023, the entire contents of which is incorporated herein by reference for all purposes.

### TECHNICAL FIELD

The present disclosure is directed at methods, systems, and techniques for automatically assessing credit risk.

### BACKGROUND

Businesses engage in various types of financial transactions with counterparties, such as extending loans to counterparties, engaging in contracts with counterparties, etc. Financial institutions in particular may engage in financial transactions with several hundred to several thousand counterparties. An important consideration for such financial transactions is a credit worthiness and/or credit risk of the different counterparties. Credit worthiness is an evaluation of the probability of the counterparty not being able to complete its payments and therefore defaults. Credit risk is a measurement of credit worthiness, where the higher the credit risk, the lower the credit worthiness, and therefore the higher the probability of the counterparty not being able to complete its payments. If a counterparty's credit worthiness changes, it would be prudent for a business to reevaluate and possibly change their relationship with that counterparty. It is thus desirable to assess a credit risk of counterparties.

### SUMMARY

According to a first aspect, there is provided a credit risk assessment method, comprising: quantifying a relevance of news topics to one or more credit risk keywords; determining one or more relevant news topics that are relevant to the one or more credit risk keywords; obtaining a plurality of news articles each tagged with one or more news topics and having an associated sentiment; determining a relevant news article as a news article tagged with the one or more relevant news topics; and assessing a credit risk of a counterparty based at least in part on the sentiment of the relevant news article.

In some aspects, the method further comprises: determining changes in a stock price of the counterparty over a predetermined time period; and assessing the credit risk of the counterparty further based on the changes in the stock price of the counterparty.

In some aspects, the method further comprises: determining changes in credit default swap spreads of the counterparty over a predetermined time period; and assessing the credit risk of the counterparty further based on the changes in the credit default swap spreads of the counterparty.

In some aspects, the relevance of news topics to one or more credit risk keywords is quantified by determining a similarity between the news topics and the one or more credit risk keywords.

In some aspects the similarity is determined using a large language model.

In some aspects, the one or more relevant news topics that are relevant to the one or more credit risk keywords are determined when the similarity exceeds a relevance threshold value.

In some aspects determining the relevant news article is further based on the sentiment associated with the news article.

In some aspects, the sentiment associated with the news article is expressed as a sentiment integer value, and wherein the news article is determined as the relevant news article further based on the sentiment integer value meeting or exceeding an integer threshold value.

In some aspects, the sentiment associated with the news article further comprises a confidence score, and wherein the news article is determined as the relevant news article further based on the confidence score.

In some aspects, the method further comprises outputting the credit risk of the counterparty for display.

In some aspects, the method further comprises: determining a plurality of news articles that mention the counterparty; determining a number of flagged news articles from the plurality of news articles that are relevant news articles tagged with the one or more news topics and that have either a high or low sentiment; and determining a proportion of the number of flagged news articles relative to the plurality of news articles that mention the counterparty, wherein the proportion of the number of flagged news articles relative to the plurality of news articles that mention the counterparty is used to assess the credit risk of the counterparty.

In some aspects, assessing the credit risk of the counterparty is performed when the proportion exceeds a threshold value.

In some aspects, assessing the credit risk of the counterparty comprises calculating a credit risk score as a probability that a credit rating of the counterparty will change.

In some aspects, assessing the credit risk is performed using a logistic regression model.

In some aspects, the one or more credit risk keywords are specific to a sector of the counterparty.

In some aspects, the method further comprises receiving a user input of the counterparty or a sector to be analyzed.

According to another aspect, there is provided a credit risk assessment system, comprising: a processor; and a non-transitory computer-readable memory having computer-executable instructions stored thereon, which when executed by the processor, configure the system to perform the method of any one the above aspects.

In some aspects, the system further comprises a database storing the plurality of news articles, the one or more news topics tagged to each of the plurality of news articles, and the sentiment associated with each of the plurality of news articles.

In some aspects, the system is further configured to access and execute a large language model to quantify the relevance of news topics to the one or more credit risk keywords.

According to another aspect, there is provided a non-transitory computer-readable memory having computer-executable instructions stored thereon, which when executed by a processor, configure the processor to perform the method of any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a representation of a credit risk assessment system;

FIG. 2 shows a representation of hardware components of an application server;

FIG. 3 shows an architecture diagram of the credit risk assessment system;

FIGS. 4A and 4B show process flow diagrams for performing credit risk assessment;

FIG. 5 shows a user flow diagram showing how a user interacts with the credit risk assessment system;

FIGS. 6A-6E show example representations of a user interface provided by the credit risk assessment system; and

FIG. 7 shows a method for performing credit risk assessment.

### DETAILED DESCRIPTION

Currently, credit adjudication is a time-consuming and manually intensive process. In financial institutions, for example, a credit risk workflow typically involves credit adjudicators evaluating various credit risk metrics set out in an internal document for assessing the credit risk of companies. The credit risk metrics may include both objective metrics (e.g. calculating debt valuations) and subjective metrics (e.g. industry concentration). The credit risk assessment is then provided to risk managers for further review.

Public news sentiment is often overlooked, or only used as a source of validation after credit rating migrations are already decided upon. Failing to account for public news sentiment leaves risk managers to take a reactive approach to investigating vulnerable counterparties after a credit change already happens. For credit adjudicators, manual analysis of each news article would create a bottleneck in their workflow and lead to inefficiencies. Moreover, manual analysis of news articles is subjective, and there is a lack of a standardized business context behind incoming news articles.

The present disclosure provides credit risk assessment systems and methods that automatically assess credit risk of a counterparty based on news article sentiment. The credit risk assessment systems and methods automatically process news articles to determine relevance and sentiment of the news articles. In accordance with the present disclosure the relevance of news articles is evaluated using a large language model to identify similarities between news article topics and credit risk keywords defined by business logic (e.g. the internal credit risk metrics). A credit risk of a counterparty can be assessed based at least in part on the sentiment of relevant news article(s). The credit risk assessment systems and methods may further assess one or more other credit risk indicators for a counterparty and the automatic assessment of credit risk can be further based on these other credit risk indicator(s) as well.

Accordingly, the credit risk assessment systems and methods in accordance with the present disclosure automatically assess credit risk of counterparties using a forward-looking set of views on counterparties based on sentiment of relevant public news articles, and automates the credit adjudication process by evaluating public news articles using business logic required to investigate a given counterparty. Additionally, the credit risk assessment systems and methods described herein provide a tool having a flexible interface to a user for reviewing credit risk assessments, which can further assist credit adjudicators and risk managers investigating a counterparty. The credit risk assessment systems and methods disclosed herein thus provide a tool for enhanced decision-making while also mitigating bottlenecks in the credit adjudication and risk analysis workflow.

In at least some embodiments herein, methods, systems, and techniques for automatically assessing credit risk of a counterparty are disclosed. A credit risk assessment method comprises: quantifying a relevance of news topics to one or more credit risk keywords; determining one or more relevant news topics that are relevant to the one or more credit risk keywords; obtaining a plurality of news articles each tagged with one or more news topics and having an associated sentiment; determining a relevant news article as a news article tagged with the one or more relevant news topics; and assessing a credit risk of a counterparty based at least in part on the sentiment of the relevant news article.

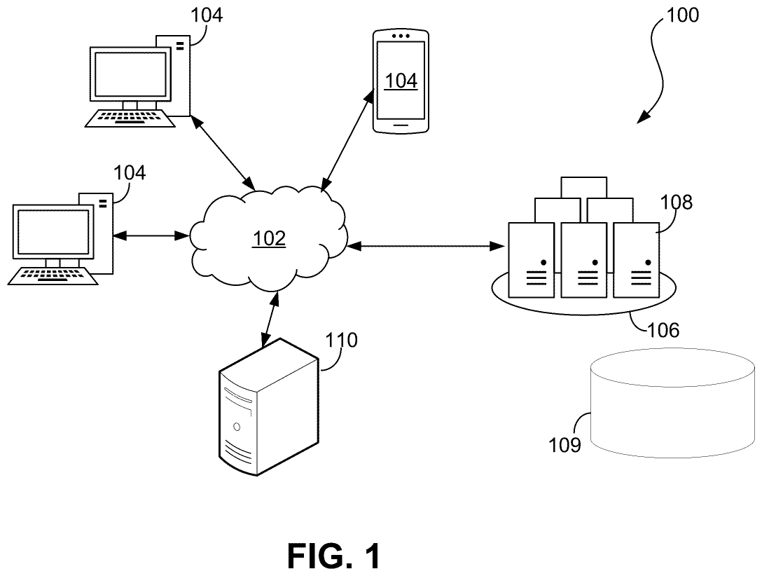

Referring now to FIG. 1, there is shown a computer network 100 that comprises an example embodiment of a credit risk assessment system. More particularly, the computer network 100 comprises a wide area network 102 such as the Internet to which various user devices 104, data center 106, and one or more third party servers 110 are communicatively coupled. The one or more third party servers 110 include servers providing news, such as online news sites, social media sites, etc. The data center 106 comprises a number of servers 108 networked together to collectively perform various computing functions including assessing credit risk as disclosed herein. The servers 108 may be distributed (cloud service). In accordance with the present disclosure, the data center 106 is configured to automatically assess credit risk and may host a credit risk platform provided by a web application accessible on user devices 104 that have access to the credit risk platform. The data center 106 further comprises a data storage 109 storing data relevant to credit risk assessment, which may include news information obtained from the third party servers 110, as well as other types of relevant information to the credit risk assessment such as stock prices and credit default swap (CDS) prices of counterparties, as disclosed in more detail herein.

In accordance with the present disclosure, the servers 108 are configured to receive or otherwise obtain news articles from the one or more third party servers 110, and to automatically process the news articles to identify news articles that are relevant to a counterparty. The credit risk assessment may be particularly concerned with news articles that have either a high or low sentiment, and may thus filter the news articles based on sentiment to identify the relevant news article(s). The servers 108 can automatically assess a credit risk of the counterparty based at least in part on the sentiment of relevant news articles, which can be conveniently displayed at user devices 104. Accordingly, news article sentiment can be used in assessing credit risk of a counterparty and evaluated based on relevance to the counterparty, providing a more complete and forward-looking credit risk assessment. Further, the credit risk assessment system provides for automated processing of such news articles, thus individuals typically involved in the credit risk assessment (e.g. credit adjudicators and/or risk managers) do not have to manually review news articles, which is both inefficient and subjective. Results of the credit risk assessment can be conveniently accessed by user devices 104, and thus the credit risk assessment system provides a flexible tool that can be utilized by those involved in the credit risk assessment process.

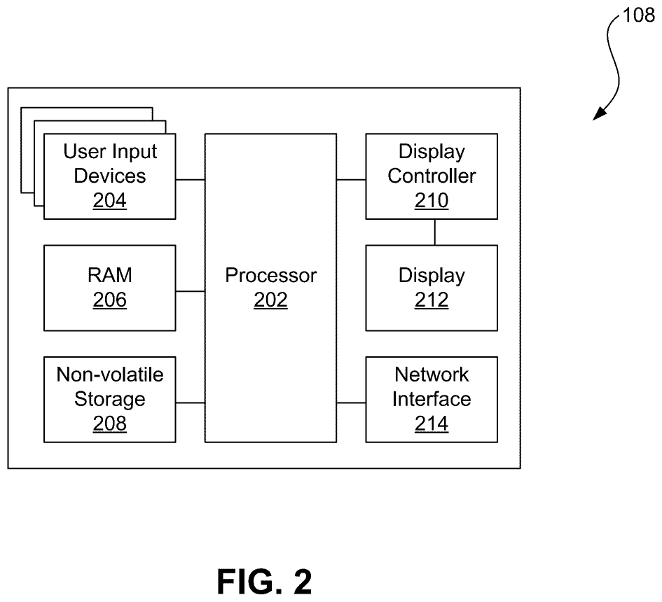

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for assessing credit risk as is described in more detail herein. Additionally or alternatively, the servers 108 may collectively perform that method using distributed computing. While the system depicted in FIG. 2 is described specifically in respect of one of the servers 108, analogous versions of the system may also be used for the user devices 104.

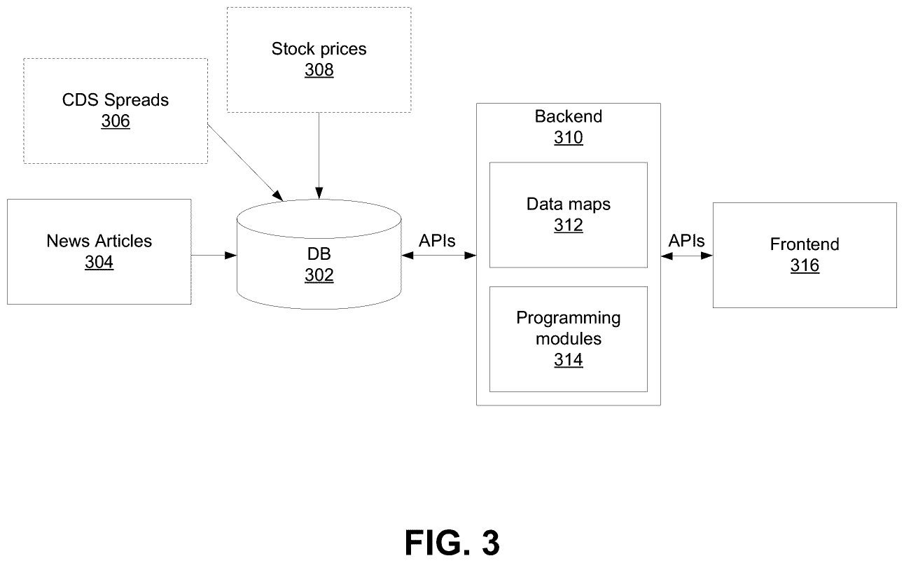

FIG. 3 shows an architecture diagram of the credit risk assessment system, and shows original data sources and different technologies the data passes through during its processing. Information for use in assessing credit risk is stored in a database 302, which may be a SQL database, for example. As described above, the credit risk assessment systems and methods in accordance with the present disclosure evaluate the sentiment of relevant news articles, and as such news articles 304 are stored in the database 302. The news articles 304 may be received or obtained from various news sites/engines. The news articles 304 are dated and may in particular have one or more topic tags associated therewith. An upstream Natural Language Processing (NLP) engine may be used to aggregate all news articles and assign a sentiment score (e.g. 1 for positive, 0 for neutral, and −1 for negative) and a confidence score (e.g. an integer from 0 to 100) to each of the news articles, as well as identify a company (e.g. by ticker) that each article is discussing. Such data associated with each news article is also stored in the database 302, and thus the database 302 stores information associated with each news article that may include at least the following: tagged topics, sentiment score, confidence score, name of the company the news article discusses, and date of the news article. As one example, the news articles 304 may be obtained from Bloomberg™ news engine, which tags news articles with topic tags indicative of topics associated with the news article. However, it will be appreciated that the news articles 304 may be obtained from various sources. In addition to news articles 304, one or more other credit risk indicators for a counterparty may also be obtained and stored in the database 302, such as CDS spreads 306 and/or stock prices 308. CDS spreads 306 may be obtained from internal sources, and stock prices 308 may be obtained from publicly available sources.

Application backend 310 communicates with the database 302 via API calls. The application backend 310 may be implemented using Flask technology. Data from the database 302 may be processed and arranged in data maps 312, such as using Jupyter Notebook running on IBM™ Pathfinder, to help run the processing pipeline in a linear manner. The application backend 310 also comprises one or more programming modules 314, implemented for example using Python™, to process the data. For example, the logic for processing the news articles 304 and any other credit risk indicator data (e.g. CDS spreads 306, stock prices 308, etc.) may be encased in its own programming module. The results from the programming modules 314 are used to assess a credit risk of a given counterparty, and may be combined to generate a credit risk score or index for a given counterparty. The application backend 310 may also comprise or access a large language model trained to identify similarities between credit risk keywords and topics, and further comprises a logistic regression model trained to calculate a probability of a given counterparty being flagged as vulnerable, which in turn is used to calculate a risk index/credit risk score for the counterparty. An application frontend 316 makes API calls to the application backend 310, which outputs the credit risk assessment and other relevant data to the application frontend 316 for display to a user. The application frontend 316 may be implemented using React technology.

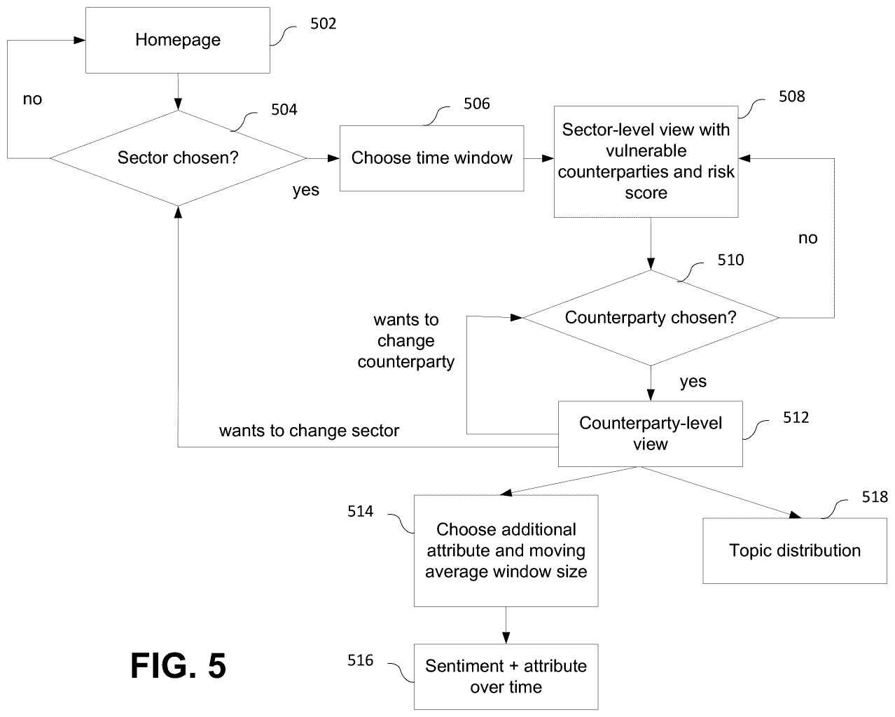

In a particular implementation, such as described with reference to the user flow diagram in FIG. 5 below, a user may access the front-end 316 of the application, input a counterparty and/or sector, and input a relevant time window (e.g. 30 days, 60 days, 90 days, etc.) with which to perform a credit risk assessment based on. The credit risk assessment system also permits the user to input an end date, so that the credit risk assessment may be performed an n number of days preceding the specified end date. The application backend 310 retrieves and processes the relevant data from the database 302 to perform a credit risk assessment, and returns the credit risk assessment and optionally the relevant data to the application frontend 316 for display.

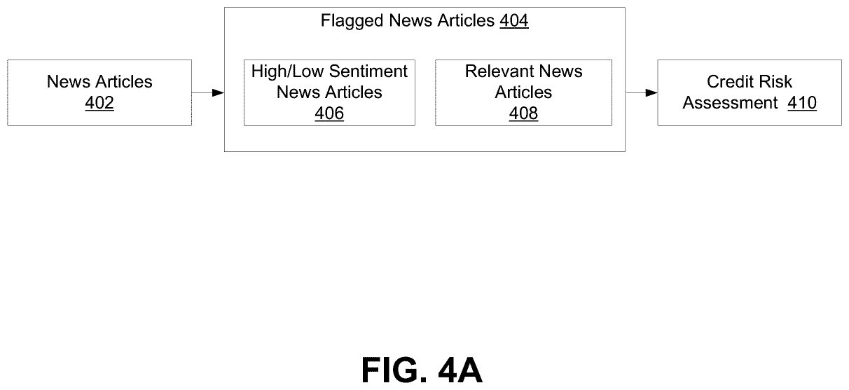

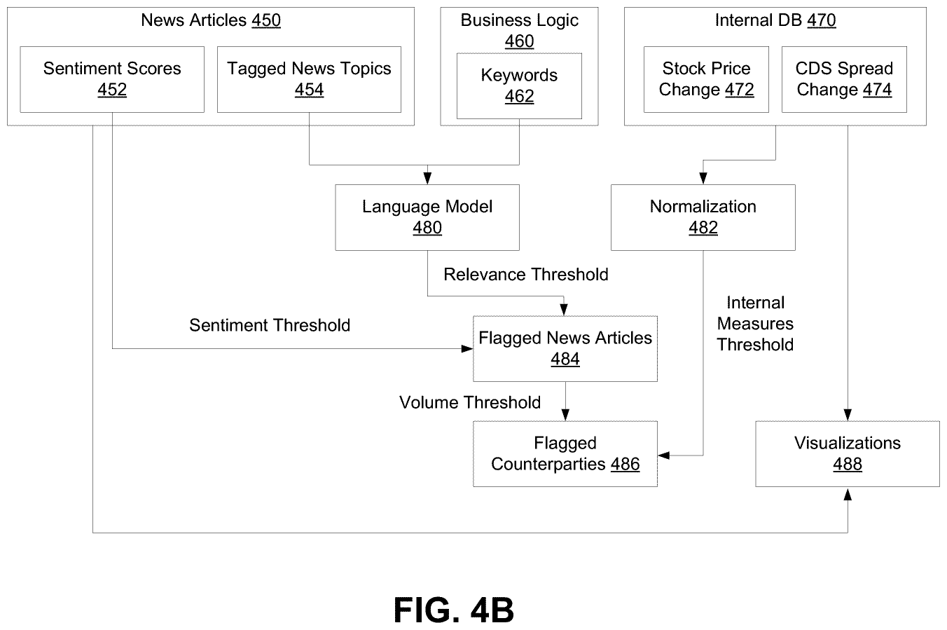

FIGS. 4A and 4B show process flow diagrams for performing credit risk assessment.

Referring to FIG. 4A, news articles and associated data as described above are obtained (402). The news articles are processed to flag news articles (404) that have a high or low sentiment (406), and that are relevant to performing a credit risk assessment of the counterparty (408). Depending on the type of credit risk assessment to be performed (e.g. based on user input), news articles having high or low sentiment may be flagged at 406. For example, if a user is interested in identifying counterparties likely to receive a credit downgrade, then news articles having low sentiment would be flagged. On the other hand, if a user is interested in identifying counterparties likely to receive a credit upgrade, then news articles having a high sentiment would be flagged. Relevant news articles are flagged at 408 based on how relevant the content of the news article is to the credit risk assessment of the counterparty and/or the sector that the counterparty operates in.

It will be appreciated that not all news articles that specifically mention a counterparty or the sector that the counterparty operates in are relevant to assess a credit risk of the counterparty. In accordance with the present disclosure, the credit risk assessment systems and methods are configured to identify relevant news articles based on credit risk keywords. More specifically, in accordance with the present disclosure a large language model is used to identify similarities between credit risk keywords used to assess credit risk and topics that are associated/tagged with news articles. For example, credit risk keywords may be derived from an internal document comprising a compiled list of terms that credit risk adjudicators presently use as guidance for manually assessing credit risk ratings. Further, as discussed above news articles may have one or more tags that denote the topics discussed or associated with the article. In one aspect of the present disclosure, a large language model such as Sentence Bidirectional Encoder Representations from Transformers (SBERT) may be used to calculate the cosine similarity between each keyword to topic pair to quantify the relevance of each news topic. Accordingly, news articles tagged with a topic that is deemed relevant to a credit risk keyword used for performing credit risk assessment can be quickly and efficiently identified as being a relevant news article.

With reference to the Table below, example news topics are listed in the rows, and example credit risk keywords are listed in the columns, with the cosine similarity for each keyword/topic pair calculated as a value between 0 and 1. A threshold value, such as 0.5, may be set in order to identify that a news topic is relevant to a credit risk keyword. The threshold value may be tuned to optimize the model's recall and accuracy, as discussed below, and users of the credit risk assessment system may also be able to adjust the thresholds and see different results. In this example with a threshold value of 0.5, the news topic “Manufactured Goods” is determined to be relevant to the credit risk keyword “Industry Concentrations”, and the news topic “Key Debt News” is determined to be relevant to the credit risk keyword “Debt Valuations”. Accordingly, when analyzing a sector or specific counterparty where the credit risk keywords “Industry Concentrations” and/or “Debt Valuations” are to be considered, news articles can be filtered out based on the news topics they are tagged with so that news articles tagged with topics “Manufactured Goods” and “Key Debt News” are considered relevant news articles. On the other hand, topics such as “Weather”, which has a very low relevance to all credit risk keywords, can be disregarded. It will be appreciated that different credit risk keywords may be used to assess the credit risk of different sectors and/or counterparties, and therefore different articles may be identified to be relevant for different sectors and/or counterparties.

| | Debt | Risk | Industry | Probability | Retail | Risk |
|---|---|---|---|---|---|---|
| | Valuations | Rating | Concentrations | of Default | Deposits | Assessment |
| Manufactured | 0.23 | 0.08 | 0.51 | 0 | 0.24 | 0.16 |
| Goods | | | | | | |
| Financials | 0.44 | 0.22 | 0.29 | 0.09 | 0.43 | 0.26 |
| Key Debt | 0.53 | 0.16 | 0.06 | 0.08 | 0.19 | 0.17 |
| News | | | | | | |
| Industrial | 0.08 | 0.21 | 0.47 | 0.10 | 0.08 | 0.31 |
| Accidents | | | | | | |
| Business | 0.14 | 0.08 | 0.21 | 0.03 | 0.13 | 0.11 |
| News | | | | | | |
| Weather | 0.07 | 0.08 | 0.12 | 0.17 | 0 | 0.1 |

A credit risk assessment is performed (410) on the flagged news articles identified at 404. Assessing the credit risk of the counterparty is based at least in part on the sentiment of the relevant news articles. The credit risk assessment is generated and output.

In some implementations, a credit risk score or index may be calculated based on a news article score represented as a number of flagged news articles that mention a counterparty, relative to a total number of news articles that mention the counterparty. As described above, flagged news articles are those deemed relevant to the credit risk keywords, which may particularly be sector specific, and that have either high or low sentiment, depending on the desired assessment. For example, if there are 10 news articles that mention Company A, and 3 of those 10 news articles are deemed relevant and have low sentiment, then the percentage of flagged news articles for Company A is 30%. The percentage of flagged news articles directed to Company A can be input into a logistic regression model, possibly along with other credit risk indicators, to calculate a credit risk score or index, which may for example be indicative of a probability that a credit rating of the counterparty will change.

Threshold values for sentiment and relevance scores may be optimized to tune the logistic regression model's precision, recall, and accuracy. The sentiment score may be calculated by multiplying the article's sentiment integer (e.g. +1, 0, or −1) by the confidence score (e.g. between 0 and 100). The relevance score may be calculated based on cosine similarity of credit risk keywords and news article topics as described above. If a news article contains even one topic tagged that exceeds a relevance score threshold value, it may be considered relevant.

Where multiple credit risk indicators scores are input into the logistic regression model (e.g. the news article score, plus one or more other credit risk indicator scores such as those described below), weightings may be applied to the credit risk indicator scores as optimized by tuning the logistic regression model.

To improve computing efficiencies and resources, only counterparties with a news article score greater than a volume threshold may be flagged and input to the logistic regression model. For example, a credit risk score may only be calculated for counterparties having a news article score of greater than 10%.

FIG. 4B shows a further flow diagram for performing credit risk assessment.

News articles 450 are obtained, and have associated sentiment scores 452 and tagged news topics 454. The sentiment scores 452 and tagged news topics 454 may be provided by an upstream NLP engine and/or the news engine that delivers the news articles. Further, business logic 460 provides credit risk keywords 462. The business logic 460 may be developed from interviews with users/credit risk professionals. The credit risk keywords 462 may be sector specific. In this implementation, an internal database 470 also stores stock price changes 472 and credit default swaps (CDS) spread changes 474, which may be applicable for analyzing credit risk of counterparties. The stock price changes 472 and CDS spread changes 474 may be calculated over different time periods from available stock price and CDS spread data.

As described above, the tagged news topics and credit risk keywords are input to a large language model 480 such as SBERT to calculate a similarity between keyword/topic pairs. From the computed similarities, relevant topics can be determined and thus relevant news articles can be identified that are tagged with topics above a relevance threshold. As also described above, sentiment scores 452 can be used to identify which of those relevant news articles have a high/low sentiment beyond a sentiment threshold (i.e. where high sentiment scores are considered to assess counterparties that are likely to receive a credit upgrade, while low sentiment scores are considered to assess counterparties that are likely to receive a credit downgrade). Relevant news articles that have a high or low sentiment score beyond a sentiment threshold may thus be flagged news articles 484.

The flagged news articles 484 may be used to assess credit risk of counterparties and to flag counterparties 486. For example, a volume or percentage of relevant news articles having a given sentiment above a volume/percentage threshold may be input into a logistic regression model and used to calculate a risk index/flag counterparties as described above. Further, in this example other credit risk indicators including stock price changes 472 and CDS spread changes 474 are considered. The stock price changes 472 and CDS spread changes 474 may be expressed as a percentage value over a given time window (e.g. the previous 90 days). The CDS spread changes 474 are considered for a set time period of the CDS spread (e.g. CDS spread for 3 months, 6 months, 1 year, 10 years, etc.). The values of the stock price changes 472 and CDS spread changes 474 over time are normalized 482 and input to the logistic regression model used to flag counterparties 486. For example, a news article score (based on a relevance score and sentiment score described above), a percentage change in stock price, and a percentage change in CDS spread, may each be input to the logistic regression model to determine a credit risk score, and thus to flag counterparties.

Information including sentiment scores, stock price changes, CDS spread changes, etc., can be conveniently output and displayed as visualizations 488 for the flagged counterparties 486. For example, visualizations 488 may include various types of information, such as a line graph of sentiment vs stock price change; a bar graph of distribution of negative, neutral, positive entries for each relevant topic; a bar graph of percentage increase of CDS spread for each spread window; a list of top 10 negative headlines, etc.

### Example

An example implementation of the credit risk assessment method to identify risky counterparties in the financial sector is described below.

Tickers and identifiers of all counterparties in the financial sector are aggregated. For each counterparty, all news articles, stock prices and CDS spread changes from a predetermined or user-defined number days (e.g. 90 days) before a user-inputted date are collected. Counterparties without a public stock price or available CDS spread data may be dropped.

### News Article Analysis

For each news article, the relevance and sentiment scores are calculated. Relevance is quantified using SBERT as described above (from 0 to 1). Sentiment is calculated by multiplying the article's sentiment integer (1 for positive, 0 for neutral, −1 for negative) with its confidence score (an integer from 0 to 100) and expressed as a decimal (from 0 to 1).

Then, all articles with a relevance score higher than 0.35 and a sentiment score lower than −0.97 are flagged.

For each counterparty, the volume of flagged articles are calculated and expressed as a percentage using its total number of news entries within the same timeframe. The percentage of flagged news articles for the counterparty is the news article score.

The counterparties with a volume higher than 10% are then flagged.

### Stock Price

For every counterparty, the stock price change is expressed as a percentage from its price a week prior to a given day within the 90-day timeframe.

### CDS Data

CDS spread is expressed as a change within a set window. For each counterparty, the percentage change for a given spread window is calculated. For example, a 10-year window may be chosen.

### Risk Index

Once values from the News Article, Stock Price, and CDS Data analysis are processed, a risk index of each counterparty is calculated by inputting these values into a logistic regression model. The counterparties may be ranked based on this risk index, e.g. to rank/identify the top 10 counterparties are considered to be the most vulnerable to downgrades.

The thresholds set to filter relevance score and sentiment score in the above example were tuned to optimize the algorithm's precision, recall, and accuracy. An iterative approach was used to discover these optimal thresholds utilizing a test dataset comprising data for three possible credit rating events: downgrade, upgrade, and unchanged. For downgrade and upgrade events, data leading up to the credit change event within a defined window was considered in the test set. Due to the abundance of unchanged events, a random subset of such unchanged events was included in the model test set, with a randomly selected date range within the unchanged period.

The model was trained to output a warning if it was predicted that there was a high probability of a credit downgrade, and to output no warning if it was predicted that there was a high probability of a credit upgrade or the credit status being unchanged. The precision for no warning was 0.78, and for warning was 0.82. The recall for no warning was 0.92, and for warning was 0.58. The accuracy of the model was 0.79. An Area Under the Curve (AUC) of the Receiver Operating Characteristic (ROC) of the logistic regression model was calculated to be 0.75. It will be appreciated that different relevance and sentiment threshold values may be set to obtain different results.

FIG. 5 shows a user flow diagram showing how a user interacts with the credit risk assessment system, e.g. the front-end 316 of the system with reference to FIG. 3.

A user is taken to a homepage (502), where they have the ability to choose a sector to analyze. A determination is made if a sector has been chosen (504), and if not (no at 504) the user remains on the homepage (502). If a sector is chosen (yes at 504) the user further chooses a time window (506) such as previous 30 days, 60 days, 90 days, etc., and optionally specify an end date. Results of the credit assessment at a sector level are shown with vulnerable counterparties and risk score presented to the user (508). For example, as described above, a sector-level credit assessment may identify a top n number of most risky counterparties, as well as an overall risk index for the sector.

A determination is made as to whether a particular counterparty is chosen (510), which may be conveniently selected from the sector-level view. If no counterparty is chosen (no at 510), the user continues to see the sector-level view. If a counterparty is chosen (yes at 510), a counterparty-level view is presented to the user (512). From the counterparty-level view, the user may be able to choose additional attributes and moving average window size (514) and view the sentiment and the attribute over time (516). The user may also be able to view a distribution of news topics relating to the counterparty and the sentiment (518), as well as various other visualizations.

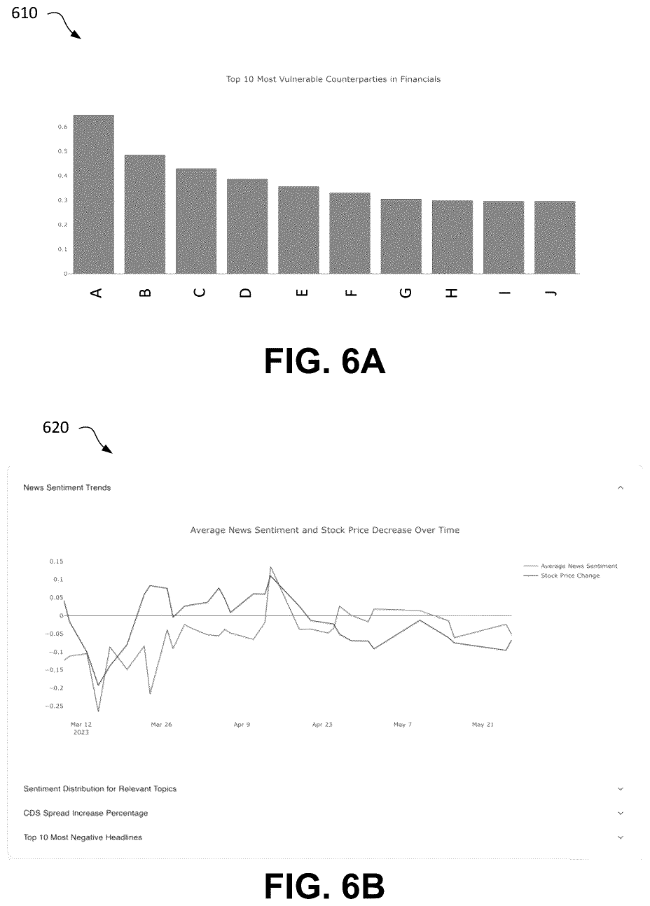

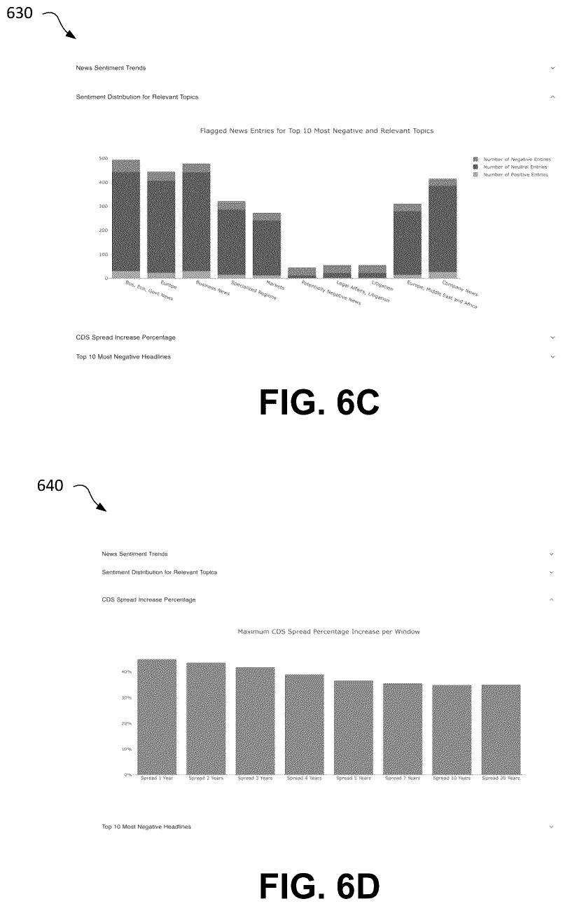

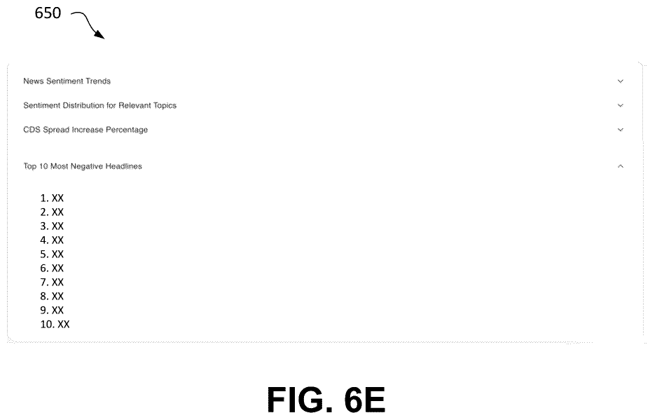

FIGS. 6A-6E show example representations of a user interface provided by the credit risk assessment system.

FIG. 6A shows an example of a UI page 610 with a sector-level view showing the top 10 most vulnerable counterparties in the sector of financial institutions based on risk index. An overall risk index and/or overall change of risk index for the whole sector can also be presented. This view helps to identify the risky counterparties based on news sentiments and provide an overview of the sector's current greatest concerns. The user has the option of choosing a sector and a specific counterparty, and can adjust the time window, based on which all the information shown on this dashboard will be calculated.

FIGS. 6B-6E show examples of UI pages with a counterparty-level view. When a user chooses a counterparty or clicks on a counterparty in the sector risk index bar chart, another visualization page may be generated and show more details for this chosen counterparty during the user chosen time window as shown in FIGS. 6B-6E. FIG. 6B shows a UI page 620 presenting a line graph of sentiment vs stock price change. FIG. 6C shows UI page 630 presenting a bar graph of distribution of negative, neutral, and positive news entries for each relevant topic, to show the dominant topics about this counterparty in the given time frame. These topics will be based on the credit risk keywords so that they are more relevant to credit rating migrations. For each topic, the chart also includes the proportion of positive and negative news, so that users know the sentiment distribution for each individual topic. FIG. 6D shows a UI page 640 presenting a bar graph of percentage increase of CDS spread for each spread window. FIG. 6E shows a UI page 650 presenting a list of top 10 negative headlines. Other visualizations may also be generated, such as a comparison of overall sentiment trends between a chosen counterparty and its belonging sector.

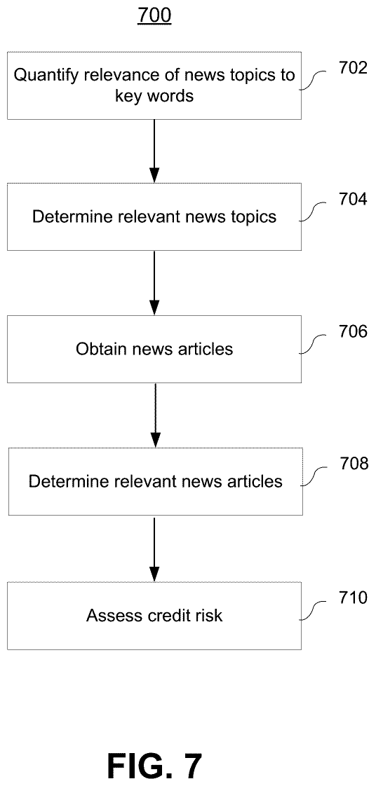

FIG. 7 shows a method 700 for performing credit risk assessment.

The method comprises quantifying a relevance of news topics to one or more credit risk keywords (702). For example, the relevance of news topics to one or more credit risk keywords may be quantified by determining a similarity between the news topics and the one or more credit risk keywords, using a large language model such as SBERT, for example. The credit risk keywords may be specific to a sector to be analyzed, and the method may comprise receiving user input of the counterparty or a sector to be analyzed.

One or more relevant news topics are determined to be relevant to the credit risk keywords (704). The relevant news topics that are relevant to the one or more credit risk keywords may be determined when the determined similarity (i.e. relevance score) exceeds a relevance score threshold value.

A plurality of news articles are obtained (706), which are each tagged with one or more news topics and have an associated sentiment. The sentiment may be expressed by a sentiment integer value and a confidence score. A sentiment score may be calculated by multiplying the sentiment integer value by the confidence score. A relevant news article is determined (708) as those news articles which are tagged with a relevant news topic, and preferably further based on the sentiment associated with the news article (e.g. that have a sentiment score exceeding a sentiment score threshold value), and optionally a confidence score associated with the sentiment.

A credit risk of a counterparty is assessed based at least in part on the sentiment of the relevant news article (710). Assessing the credit risk of the counterparty may comprise calculating a credit risk score, which may represent a probability that a credit rating of the counterparty will change. The credit risk score may be calculated using a logistic regression model. The credit risk score may comprise calculating a news article score based on the relevance and the sentiment of news articles that mention the counterparty. The news article score may be calculated by determining a plurality of news articles that mention the counterparty, determining a number of flagged news articles from the plurality of news articles that are relevant news articles tagged with the one or more news topics and that have either a high or low sentiment exceeding a threshold, and determining a proportion or percentage of the flagged news articles relative the plurality of news articles that mention the counterparty. Other credit risk indicators could also be determined and used to assess the credit risk of the counterparty. For example, the method may further comprise determining changes in a stock price of the counterparty over a predetermined time period, and assessing the credit risk of the counterparty further based on the changes in the stock price of the counterparty. Additionally or alternatively, the method may further comprise determining changes in credit default swap spreads of the counterparty over a predetermined time period, and assessing the credit risk of the counterparty further based on the changes in the credit default swap spreads of the counterparty. Each of these credit risk indicators (news article score, stock price change, CDS spread change) can be input into the logistic regression model. The credit risk assessment may be output, for example graphically and/or numerically, in a user interface, and as a particular implementation may for example provide a dashboard with detailed visualizations.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A credit risk assessment method, comprising:
quantifying a relevance of news topics to one or more credit risk keywords;
determining one or more relevant news topics that are relevant to the one or more credit risk keywords;
obtaining a plurality of news articles each tagged with one or more news topics and having an associated sentiment;
determining a relevant news article as a news article tagged with the one or more relevant news topics; and
assessing a credit risk of a counterparty based at least in part on the sentiment of the relevant news article.

2. The credit risk assessment method of claim 1, further comprising:
determining changes in a stock price of the counterparty over a predetermined time period; and
assessing the credit risk of the counterparty further based on the changes in the stock price of the counterparty.

3. The credit risk assessment method of claim 1, further comprising:
determining changes in credit default swap spreads of the counterparty over a predetermined time period; and
assessing the credit risk of the counterparty further based on the changes in the credit default swap spreads of the counterparty.

4. The credit risk assessment method of claim 1, wherein the relevance of news topics to one or more credit risk keywords is quantified by determining a similarity between the news topics and the one or more credit risk keywords.

5. The credit risk assessment method of claim 4, wherein the similarity is determined using a large language model.

6. The credit risk assessment method of claim 4, wherein the one or more relevant news topics that are relevant to the one or more credit risk keywords are determined when the similarity exceeds a relevance threshold value.

7. The credit risk assessment method of claim 1, wherein determining the relevant news article is further based on the sentiment associated with the news article.

8. The credit risk assessment method of claim 7, wherein the sentiment associated with the news article is expressed as a sentiment integer value, and wherein the news article is determined as the relevant news article further based on the sentiment integer value meeting or exceeding an integer threshold value.

9. The credit risk assessment method of claim 8, wherein the sentiment associated with the news article further comprises a confidence score, and wherein the news article is determined as the relevant news article further based on the confidence score.

10. The credit risk assessment method of claim 1, further comprising outputting the credit risk of the counterparty for display.

11. The credit risk assessment method of claim 1, further comprising:
determining a plurality of news articles that mention the counterparty;
determining a number of flagged news articles from the plurality of news articles that are relevant news articles tagged with the one or more news topics and that have either a high or low sentiment; and
determining a proportion of the number of flagged news articles relative to the plurality of news articles that mention the counterparty, wherein the proportion of the number of flagged news articles relative to the plurality of news articles that mention the counterparty is used to assess the credit risk of the counterparty.

12. The credit risk assessment method of claim 11, wherein assessing the credit risk of the counterparty is performed when the proportion exceeds a threshold value.

13. The credit risk assessment method of claim 1, wherein assessing the credit risk of the counterparty comprises calculating a credit risk score as a probability that a credit rating of the counterparty will change.

14. The credit risk assessment method of claim 1, wherein assessing the credit risk is performed using a logistic regression model.

15. The credit risk assessment method of claim 1, wherein the one or more credit risk keywords are specific to a sector of the counterparty.

16. The credit risk assessment method of claim 1, further comprising receiving a user input of the counterparty or a sector to be analyzed.

17. A credit risk assessment system, comprising:
a processor; and
a non-transitory computer-readable memory having computer-executable instructions stored thereon, which when executed by the processor, configure the system to:
quantify a relevance of news topics to one or more credit risk keywords;
determine one or more relevant news topics that are relevant to the one or more credit risk keywords;
obtain a plurality of news articles each tagged with one or more news topics and having an associated sentiment;
determine a relevant news article as a news article tagged with the one or more relevant news topics; and
assess a credit risk of a counterparty based at least in part on the sentiment of the relevant news article.

18. The credit risk assessment system of claim 17, further comprising a database storing the plurality of news articles, the one or more news topics tagged to each of the plurality of news articles, and the sentiment associated with each of the plurality of news articles.

19. The credit risk assessment system of claim 17, wherein the system is further configured to access and execute a large language model to quantify the relevance of news topics to the one or more credit risk keywords.

20. A non-transitory computer-readable memory having computer-executable instructions stored thereon, which when executed by a processor, configure the processor to:
quantify a relevance of news topics to one or more credit risk keywords;
determine one or more relevant news topics that are relevant to the one or more credit risk keywords;
obtain a plurality of news articles each tagged with one or more news topics and having an associated sentiment;
determine a relevant news article as a news article tagged with the one or more relevant news topics; and
assess a credit risk of a counterparty based at least in part on the sentiment of the relevant news article.
